(19) United States
(12) Patent Application Publication
(10) Pub. No.: US 2017/0075531 A1
(43) Pub. Date: Mar. 16, 2017

(54) SPECIFYING COLUMN PLACEMENT OF GEOGRAPHICALLY RELATED CONTENT

(71) Applicant: GOOGLE INC., Mountain View, CA (US)

(72) Inventors: Takahiro Kosakai, Tokyo (JP); Jesse Greenwald, San Mateo, CA (US)

(73) Assignee: GOOGLE INC., Mountain View, CA (US)

(21) Appl. No.: 14/015,236

(22) Filed: Aug. 30, 2013

Related U.S. Application Data
(60) Provisional application No. 61/844,339, filed on Jul. 9, 2013.

(51) Int. Cl. G06F 3/0484

(52) U.S. Cl. CPC G06F 3/0484

(57) ABSTRACT

A map data server sends content (e.g., text, images, URLs, etc.) that is related to a point of interest, a city, or other elements displayed on an interactive digital map (i.e., geographically related content) to a user device in response to a request for map data. The content includes declarative indications for placement of the geographically related content on the display of a client device. Such declarative indications may include an indication of a layout (e.g., portrait or landscape with a certain number of columns) and a specification of content placement within the layout (e.g., in a column “two,” a middle column, the right most column, etc.). A software application, executed by the user device, displays the server-supplied content according to the declarative indications from the map data server.

### CROSS REFERENCE TO RELATED APPLICATIONS

This application claims the benefit of U.S. Provisional Patent Application No. 61/844,339 that was filed on Jul. 9, 2013 the disclosure of which is hereby incorporated herein by reference in its entirety for all purposes.

### FIELD OF TECHNOLOGY

The present disclosure relates generally to displaying interactive digital maps and, more particularly, to placing geographic items on an interactive digital map based on declarative indications corresponding to available layouts within the display of a client computing device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many software applications that display interactive digital maps also display additional geographically related content in various formats. For example, when the user positions the viewport (i.e., a virtual frame that delimits the viewing region of an interactive digital map displayed within a display device 106C of the client computing device 106 or a virtual frame that delimits the viewing region of any interactive display) within an interactive display, a network server can provide photographs, links to websites, etc. for points of interest (POIs) located in the area to a client device that executes the mapping application. The mapping application can display the additional content in an informational window, “bubble,” etc.

When displaying geographically related content, the mapping application in some cases determines a particular format and layout or placement for the display of the content. For example, a mapping application may determine to display content in a portrait, landscape, multi-column, one column, etc. format at particular positions. In such a case, the mapping application 120 may execute an instruction to locally select the format and placement applicable to server-provided content. As such, because the placement algorithm for the content is coded in the client device, it is not flexible. For example, the algorithm cannot handle new types of content that did not exist at the time the client code was written, the algorithm cannot be changed later based on a new user study or for other reasons, and the algorithm cannot handle complicated computation as the CPU resource on the client is limited.

### SUMMARY

The features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A map data server sends content (e.g., text, images, URLs, etc.) that may be related to a point of interest, a city, or other elements displayed on an interactive digital map (i.e., geographically related content) to a user device in response to a request for map data. The content includes declarative indications for placement of the geographically related content on the display of a client device. Such declarative indications may include an indication of a layout (e.g., portrait or landscape with a certain number of columns) and a specification of content placement within the layout (e.g., in a column “two,” a middle column, the right most column, etc.). A software application, executed by the user device, displays the server-supplied content according to the declarative indications from the map data server.

In one embodiment, a computer-implemented method may position geographically-related content within a viewport of a client computing device configured to display an interactive digital map. The method may receive map data via a computer network in response to a request from the client computing device. The map data may include a graphic element, geographically related data, and a declarative indication. Both the geographically related data and the declarative indication correspond to the graphic element. The method may also determine an orientation of a viewport within a display device of the client computing device. The viewport may include a virtual frame that delimits a viewing region of interactive data displayed within a display device of the client computing device. Further, the method may display the geographically related content according to the determined orientation of the viewport and the declarative indication.

In another embodiment, a mapping system may be configured to position geographically-related content within a viewport of a client computing device configured to display an interactive digital map. The system may comprise a client device including a first processor and a first memory including instructions executed on the first processor. When executed on the first processor, the instructions may receive map data via a computer network in response to a request from the client computing device. The map data may include a graphic element, geographically related data, and a declarative indication. Both the geographically related data and the declarative indication may correspond to the graphic element. The instructions may also determine an orientation of a viewport within a display device of the client computing device. The viewport may include a virtual frame that delimits a viewing region of interactive data displayed within a display device of the client computing device. Finally, the instructions may display the geographically related content according to the determined orientation of the viewport and the declarative indication. The orientation of the viewport may include one or more of a layout and one or more placement positions. The declarative indication may include a placement indication for the geographically related data within the viewport and the placement indication may correspond to the determined viewport orientation.

In a still further embodiment, a tangible computer-readable medium may include non-transitory computer readable instructions stored thereon for positioning geographically-related content within a viewport of a client computing device configured to display an interactive digital map. When executed, the instructions may receive map data via a computer network in response to a request from the client computing device. The map data may include a graphic element, geographically related data, and a declarative indication. Both the geographically related data and the declarative indication may correspond to the graphic element. The instructions may also determine an orientation of a viewport within a display device of the client computing device. The viewport may include a virtual frame that delimits a viewing region of interactive data displayed within a display device of the client computing device. Finally, the instructions may display the geographically related content according to the determined orientation of the viewport and the declarative indication.

### BRIEF DESCRIPTION OF THE DRAWINGS

FIG. 1 illustrates an exemplary system including a tangible computer-readable storage medium for placing geographically related content on an interactive digital map;

FIG. 2 illustrates a data structure for map data including geographically related content and declarative indications for placement of the geographically related content within an interactive digital map;

FIG. 3 illustrates a flowchart for a computer-implemented method of placing geographically related content on an interactive digital map;

FIG. 4A illustrates placement of geographically related content within an interactive digital map including a viewport in a first orientation; and

FIG. 4B illustrates placement of geographically related content within an interactive digital map including a viewport in a second orientation.

The figures depict embodiments of the present invention for purposes of illustration only. One skilled in the art will readily recognize from the following discussion that alternate embodiments of the structures and methods illustrated herein may be employed without departing from the principles of the invention described herein.

### DETAILED DESCRIPTION

A map data server sends geographically related content (e.g., text, images, URLs, etc.) to a user device along with declarative indications for placement of the content on a display. Such declarative indications may include an indication of a layout (e.g., portrait or landscape with a certain number of columns) and a specification of content placement within the layout (e.g., in a column “two,” a middle column, the right most column, etc.). A software application, executed by the user device, displays the server-supplied content according to the declarative indications from the map data server.

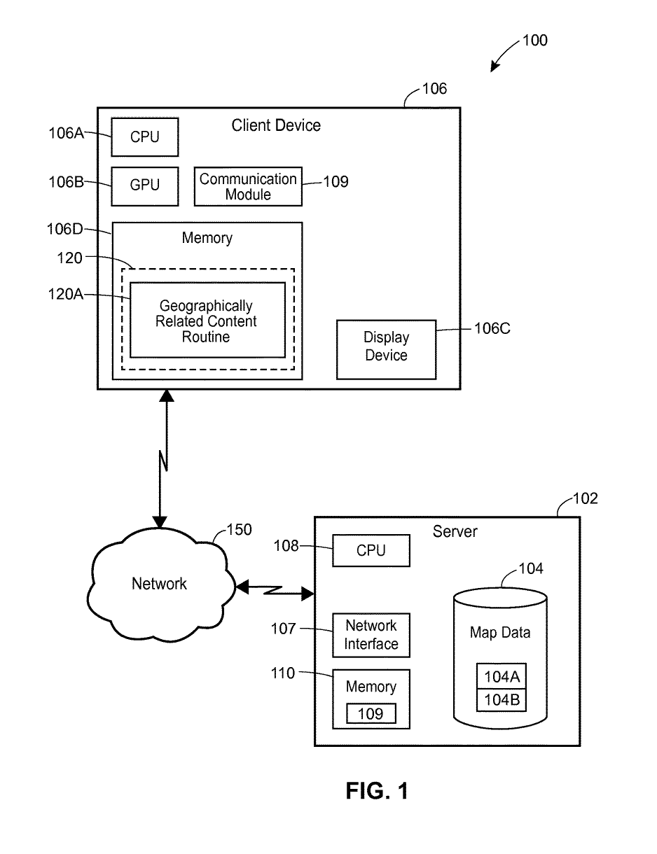

FIG. 1 schematically illustrates an example system 100 scenario in which a map data server 102 (e.g., including one or more CPUs, network interfaces, memories, etc.) sends map data 104 and geographically related content 104A from the server 102 to a client computing device 106 (e.g., a smart phone including a CPU 106A, GPU 106B, display device 106C, memory storing software applications 106D, etc.) along with declarative indications 104B for the display of the geographically related content. The geographically related content 104A is sent via the network 150, which may be any suitable mobile or wide area network (e.g., the Internet), and may include images, links to websites, text descriptions, etc. related to a POI, for example. The network 150 may be a proprietary network, a secure public internet, a virtual private network or some other type of network, such as dedicated access lines, plain ordinary telephone lines, satellite links, combinations of these, etc. Where the network 150 comprises the Internet, data communications may take place over the network 150 via an Internet communication protocol.

In some embodiments, the client device 106 includes a mapping application 120 stored in a memory 106D and executed by the CPU 106A and GPU 106B. The mapping application 120 may receive the map data 104 and geographically related content 104A including an itemized list 104B from the server 102. For example, using a network interface 107, the server 102 may send the data 104 when a CPU 108 of the server 102 executes an instruction of a mapping module 109 stored in the memory 110. The server 102 may send the data 104 using the network interface 107 via the network 150 to a communication module 109 of the client device 106. A geographically related content routine 120A stored within the memory 106D of the device 106 may include instructions to place the content 104A within the display device 106C by processing the itemized list 104B. The itemized list 104B may include declarative indications of one or more preferred placements for display of the content 104A, as further described herein. The routine 120A may then execute instructions to display the content 104A within the display device 106C of the client device according to the itemized list 104B.

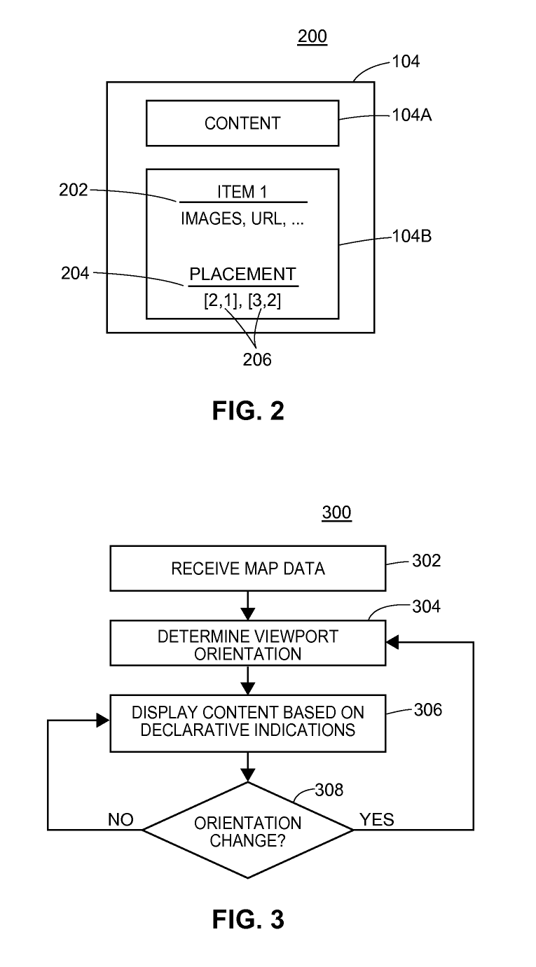

With reference to FIG. 2, data 200 sent from the mapping server 102 may include map data 104 with geographically related content 104A and an itemized list 104B. Content 104A may include images, URLs, text, and other data that may be related to an item or location on a digital map. For example, a restaurant or other business illustrated on a digital map may have one or more images that are related to the business. When that business is placed on a digital map, the related content 104A may also be available to a user that desired more information about that business. The geographically related content 104A may be listed as one or more items 202 within the itemized list 104B. Each item 202 (e.g., “Item 1”) in the itemized list 104B may include a declarative indication 204 of one or more preferred placements for display of the content within the display device 106C of the client device 106. As illustrated in FIG. 2, an “Item 1” 202 in the itemized list 104B may be accompanied by a declarative indication 204. The declarative indication may include an ordered list of elements (e.g., a tuple), a collection of data items (e.g., an array), or any other type of data collection. FIG. 2 shows tuples 206 (i.e., [2,1] and [3,2]). Each number of the tuples 206 may indicate a layout or placement for one or more of the items 202 that correspond to the content 104A. For example, the second number in each tuple 206 (i.e., “1” and “2”) may correspond to different types of layouts. For example, a “1” may correspond to a portrait layout and a “2” may correspond to a landscape layout. Further, a first number of the tuples 206 (i.e., “2” and “3”) may correspond to specific columns within the portrait and landscape layouts, respectively. Thus, in the example illustrated by FIG. 2, the declarative indications 204 accompanying “Item 1” indicate that “Item 1” content should be displayed in column “2” of a portrait layout and in column “3” of a landscape layout.

FIG. 3 illustrates an exemplary flowchart for a computer-implemented method 300 for placing geographic items on an interactive digital map based on declarative indications corresponding to available layouts within the display of a client computing device. The method 300 may include one or more blocks, modules, functions or routines in the form of computer-executable instructions that are stored in a tangible computer-readable medium and executed using a processor 106A, 108 of a computing device (e.g., a computing device of the system 100, as described herein). The method 300 may be included as part of any modules of a computing environment for the system 100, for example, or as part of a module that is external to such a system. For example, the method 300 may be part of a mapping module 120 or the geographically related content routine 120A executing within a computing device (e.g., the mapping server 102 or the client computing device 106). FIG. 3 will be described with reference to FIGS. 1, 2, and 4 for ease of explanation, but the method 300 can of course be utilized with other elements described herein.

The method 300 may include an application including a set of computer-executable instructions (e.g., the graphically related content routine 120A) that are executable on one or more processors (e.g., processors 106A, 108) to display the geographically related content 104A according to declarative indications within the itemized list 104B sent by the map data server 102 to the client device 106. At function 302, the method 300 may receive map data 104 from the server 102 in response to a request from the client device 106. As described herein, the map data 104 may include graphic data that is used to render an interactive digital map at the client computing device 106. The graphic data may include vector graphics data rendered at the client device 106, raster (bitmap) data, or both. Further, the map data 104 may include geographically-related data 104A that corresponds to other graphic elements represented at geographic locations within a viewport. For example, the geographically related data 104A may include photographs, links to websites, text, and other interactive data corresponding to points of interest that are graphically represented on an interactive digital map. The received data 104 may also include an itemized list 104B. The list 104B may include items 202 that correspond to various graphic elements that are displayed within an interactive digital map. For example, an item 202 may correspond to a description, digital image, or other content for a graphic element representing a building or other graphic element within a digital map displayed on the display device 106C. A declarative indication 204 within the itemized list 104B may correspond to the item 202 in the form of an ordered list of elements (e.g., one or more tuples 206), a collection of data items (e.g., an array), or other type of data that indicates a layout and placement of the corresponding item 202.

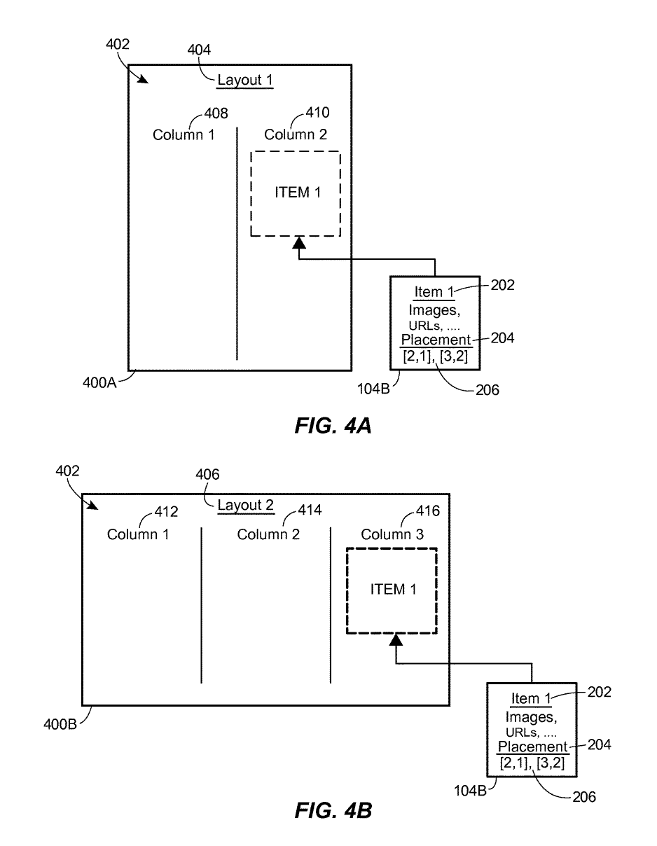

In some implementations, the map data server 102 may send the geographically related content 104A in the form of an itemized list 104B of content, where each item (e.g., “Item 1”) in the itemized list 104B is accompanied by, or includes, one or more declarative indications 204 of one or more preferred placements within the viewport 400A, 400B for display of the content. In the example scenario, “Item 1” in the itemized list 104B may be accompanied by server-specified declarative indications in the form of the tuples [2,1] and [3,2]. The second number in each tuple, “1” and “2,” may correspond to portrait and landscape layouts respectively, and the first number, “2” and “3,” may correspond to specific columns within the portrait and landscape layouts respectively. Thus, in the example scenario, the declarative indications accompanying “Item 1” indicate that “Item 1” content should be displayed in column “2” of a portrait layout and in column “3” of a landscape layout (as illustrated in FIGS. 4A and 4B).

At function 304, the method 300 may execute an instruction to determine an orientation of the viewport 400A, 400B (FIGS. 4A and 4B). For example, a viewport 400A, 400B may include a virtual frame that delimits the viewing region of a digital map 402 that is displayed on a display device 106C of the client device 106. The viewport 400A, 400B may also include a virtual frame that delimits the viewing region of interactive data that is displayed on a display device 106C of the client device 106. The viewport orientation may include one or more of a layout 404,406 and one or more placement positions (408, 410, 412, 414, and 416). In some embodiments, the layout 404,406 includes a portrait or a landscape layout orientation for the viewports 400A, 400B, respectively, and the placement positions include one or more columns, rows, or other physical positions on the interactive digital map displayed within the viewport.

At function 306, the method 300 may execute an instruction to display the geographically-related content 104A according to the declarative indications 204. In some embodiments, the declarative indications 204 include an ordered list of elements (e.g., tuples), a collection of data items (e.g., an array) or other data that correspond to an orientation of the viewport and a position within the viewport 400A, 400B. The position within the viewport may depend on the orientation of the viewport. For example, if the mobile device 104 is a smart phone displaying a digital map in a portrait layout that is indicated by a declarative indication (e.g., a tuple with a “1” in its second position), the client device 106 may display “Item 1” content (e.g., including images, URLs, etc.) in a position indicated by the declarative indication (e.g., column “2” of the portrait layout). Whereas, if the mobile device 104 is a tablet computer displaying a digital map in a landscape layout that is indicated by the declarative indication (e.g., a tuple with a “2” in its second position), the client device 106 may display “Item 1” content in a position indicated by the declarative indication (e.g., column “3” of a landscape layout).

At function 308, the method 300 may execute an instruction to determine if the orientation of the viewport 400A, 400B is changed. For example, changing an orientation of the client device 106 may cause the device 106 to execute an instruction to transition from a portrait layout (i.e., a first orientation) to a landscape layout (i.e., a second orientation). In some embodiments, the device 106 may execute the instruction to transition to different viewport orientations in response to a rotation or change in orientation of the mobile device 106. An accelerometer or other hardware or software element of the device 106 may include instructions to detect the device's change in orientation. When the method 300 determines that the viewport 400A, 400B orientation is changed, then the method 300 may return to function 304 to determine the orientation as described above. The method 300 may then execute function 306 to display the content based on one or more declarative indications 204 and place the content of “Item 1” previously displayed in column “2” of the portrait layout in column “3” of the landscape layout. If the orientation of the viewport 400A, 400B does not change, then the method 300 may continue to display the content as in function 306.

Because content is placed according to server-specified declarative indications, a server may determine optimal or appropriate content placement based on the type, amount, etc. of the content or relationships between content, in some implementations. For example, content related to a geographic query for “coffee shops” may be grouped (e.g., placed together on a display) according to certain relationships such as “trendy” coffee shops, “franchise” coffee shops, “independent” coffee shops, etc. In another illustrative example, a server may place content with images in a right column and text descriptions in a left column based on studies of user experience.

Generally, a map data server and a mobile device may use any suitable number of layouts and/or number of conceptual structures (e.g., columns, rows, text boxes, captions, etc.) to declare and utilize, respectively, indications of content placement. Further, declarative indications for content placement may be sent to mobile devices in any suitable form (e.g., tuples, an array, keywords, identification numbers, codes, etc.) and may be sent with or separate from corresponding geographically related content.

Still further, declarative indications for display placement may include conditional, additive, temporal, etc. constraints, in some implementations. For example, a declarative indication for placement of content may include a conditional constraint specifying column preference in the event that a given column is “full” of content, or has no room for display of content. In another illustrative example, a declarative indication for placement of content may include an additive constraint specifying a ranking, or prioritization, of content such that content is placed at the top or bottom of a particular column.

The following additional considerations apply to the foregoing discussion. Throughout this specification, plural instances may implement components, operations, or structures described as a single instance. Although individual operations of one or more methods and functions are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines and functions described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of tangible algorithms or operations on data stored as bits or tangible signals within a computer storage memory. These algorithms are examples of techniques used by those of ordinary skill in the data processing arts to convey the substance of their work to others skilled in the art. As used herein, an algorithm, function, routine, or block is a self-consistent sequence of operations or similar processing leading to a desired result. In this context, algorithms, functions, routines, blocks, and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment or embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for utilizing secure private data models to customize map content through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for positioning geographically related content within a viewport of a display device of a client computing device configured to display interactive data, the method comprising:
receiving, at the client computing device, map data via a computer network in response to a request from the client computing device, the map data including a graphic element, the geographically related content and a declarative indication, wherein the geographically related content corresponds to the graphic element, wherein the declarative indication includes at least a first placement indication and a second placement indication for the geographically related content within the viewport, wherein the first placement indication specifies a first position, within a layout of the viewport, at which the geographically related content is to be displayed when the viewport is in a landscape orientation, [[and]] wherein the second placement indication specifies a second position, within the layout of the viewport, at which the geographically related content is to be displayed when the viewport is in a portrait orientation, wherein each of the first placement indication and the second placement indication specifies a respective column, and wherein the declarative indication further includes one or both of (i) a conditional constraint specifying a placement preference when one of the respective columns cannot display the geographically related content, and (ii) a temporal constraint specifying a time to place the geographically related content within the viewport;
determining whether the viewport within the display device of the client computing device is in the landscape orientation or the portrait orientation, the viewport including a virtual frame that delimits a viewing region of the interactive data displayed within the display device of the client computing device; and
displaying the geographically related content according to the determined orientation of the viewport and the declarative indication.

2-6. (canceled)

7. The computer-implemented method of claim 1, wherein the declarative indication further includes an additive constraint specifying a prioritization of the geographically related content to place the geographically related content at a top position or a bottom position of the column.

8. The computer-implemented method of claim 1, wherein the graphic element corresponds to a point of interest and includes vector graphics data for rendering the graphic element at the client computing device, and wherein the geographically related content includes one or more of photographs, links to websites, and text.

9. A mapping system configured to position geographically related content within a viewport, the system comprising:
a client computing device including a display device, a processor, and a memory including instructions executed on the processor to:
receive map data via a computer network in response to a request from the client computing device, the map data including a graphic element, geographically related content, and a declarative indication, wherein the geographically related content corresponds to the graphic element, wherein the declarative indication includes at least a first placement indication and a second placement indication for the geographically related content within the viewport, wherein the first placement indication specifies a first position, within a layout of the viewport, at which the geographically related content is to be displayed when the viewport is in a landscape orientation, wherein the second placement indication specifies a second position, within the layout of the viewport, at which the geographically related content is to be displayed when the viewport is in a portrait orientation, wherein each of the first placement indication and the second placement indication specifies a respective column, and wherein the declarative indication further includes one or both of (i) a conditional constraint specifying a placement preference when one of the respective columns cannot display the geographically related content, and (ii) a temporal constraint specifying a time to place the geographically related content within the viewport;
determine whether the viewport within the display device of the client computing device is in the landscape orientation or the portrait orientation, the viewport including a virtual frame that delimits a viewing region of the interactive data displayed within the display device of the client computing device; and
display the geographically related content according to the determined orientation of the viewport and the declarative indication.

10-11. (canceled)

12. The mapping system of claim 9, wherein the declarative indication further includes an additive constraint specifying a prioritization of the geographically related content to place the geographically related content at a top position or a bottom position of the column.

13. The mapping system of claim 9, wherein the graphic element corresponds to a point of interest and includes vector graphics data for rendering the graphic element at the client computing device, and wherein the geographically related content includes one or more of photographs, links to websites, and text.

14. A non-transitory computer-readable medium including computer-readable instructions stored thereon for positioning geographically related content within a viewport of a display device of a client computing device configured to display interactive data, the instructions to:
receive, at the client computing device, map data via a computer network in response to a request from the client computing device, the map data including a graphic element, the geographically related content and a declarative indication, wherein the geographically related content corresponds to the graphic element, wherein the declarative indication includes at least a first placement indication and a second placement indication for the geographically related content within the viewport, wherein the first placement indication specifies a first position, within a layout of the viewport, at which the geographically related content is to be displayed when the viewport is in a landscape orientation, wherein the second placement indication specifies a second position, within the layout of the viewport, at which the geographically related content is to be displayed when the viewport is in a portrait orientation, wherein each of the first placement indication and the second placement indication specifies a respective column, and wherein the declarative indication further includes one or both of (i) a conditional constraint specifying a placement preference when one of the respective columns cannot display the geographically related content, and (ii) a temporal constraint specifying a time to place the geographically related content within the viewport;
determine whether the viewport within the display device of the client computing device is in the landscape orientation or the portrait orientation, the viewport including a virtual frame that delimits a viewing region of the interactive data displayed within the display device of the client computing device; and
display the geographically related content according to the determined orientation of the viewport and the declarative indication.

15-18. (canceled)

19. The non-transitory computer-readable medium of claim 14, wherein the declarative indication further includes an additive constraint specifying a prioritization of the geographically related content to place the geographically related content at a top position or a bottom position of the column.

20. The non-transitory computer-readable medium of claim 14, wherein the graphic element corresponds to a point of interest and includes vector graphics data for rendering the graphic element at the client computing device, and wherein the geographically related content includes one or more of photographs, links to websites, and text.

21. The computer-implemented method of claim 1, wherein the declarative indication includes the conditional constraint specifying the placement preference when one of the respective columns cannot display the geographically related content.

22. The computer-implemented method of claim 1, wherein the declarative indication further includes the temporal constraint specifying the time to place the geographically related content within the viewport.

23. The mapping system of claim 9, wherein the declarative indication includes the conditional constraint specifying the placement preference when one of the respective columns cannot display the geographically related content.

24. The mapping system of claim 9, wherein the declarative indication further includes the temporal constraint specifying the time to place the geographically related content within the viewport.

25. The non-transitory computer-readable medium of claim 14, wherein the declarative indication includes the conditional constraint specifying the placement preference when one of the respective columns cannot display the geographically related content.

26. The non-transitory computer-readable medium of claim 14, wherein the declarative indication further includes the temporal constraint specifying the time to place the geographically related content within the viewport.
